(19) United States
(12) Patent Application Publication
(10) Pub. No.: US 2022/0048519 A1
(43) Pub. Date: Feb. 17, 2022

(54) INFORMATION PROCESSING APPARATUS, INFORMATION PROCESSING METHOD, AND PROGRAM

(71) Applicant: Toyota Jidosha Kabushiki Kaisha, Toyota-shi (JP)

(72) Inventors: Yuko Mizuno, Nagoya-shi (JP); Shin Sakurada, Toyota-shi (JP); Kazuya Nishimura, Anjo-shi (JP); Takumi Fukunaga, Nagoya-shi (JP); Soutaro Kaneko, Nagoya-shi (JP); Rio Minagawa, Nagoya (JP)

(73) Assignee: Toyota Jidosha Kabushiki Kaisha, Toyota-shi (JP)

(21) Appl. No.: 17/366,491

(22) Filed: Jul. 2, 2021

(30) Foreign Application Priority Data
Aug. 11, 2020 (JP) 2020-135652

(51) Int. Cl. B60W 40/09; G06K 9/00; G06Q 10/02

(52) U.S. Cl. CPC B60W 40/09; B60W 2540/22; G06Q 10/02; G06K 9/00302

(57) ABSTRACT

An information processing apparatus acquires first information on a behavior of a first vehicle associated with each operation performed by a first driver on the first vehicle and second information on a change in emotion of a user who shares the first vehicle, extracts information on a change in the user's emotion associated with each behavior of the first vehicle by associating the first information with the second information, determines a user's evaluation of the first driver's driving based on information on the change in the user's emotion associated with each behavior of the first vehicle, and stores the determined evaluation in a storage unit.

### CROSS-REFERENCE TO RELATED APPLICATION

This application claims priority to Japanese Patent Application No. 2020-135652 filed on Aug. 11, 2020, incorporated herein by reference in its entirety.

### BACKGROUND

### 1. Technical Field

The present disclosure relates to a technique for matching a vehicle driver to a user who desires to travel in a vehicle.

### 2. Description of Related Art

Japanese Unexamined Patent Application Publication No. 2016-137203 (JP 2016-137203 A) discloses a technique related to a control device which responds to emotions of an occupant in a vehicle. JP 2016-137203 A discloses that a control device includes an emotion interpreting unit. The emotion interpreting unit interprets emotions of each occupant in a vehicle based on biological information. A control unit controls a driving motion guidance unit such that the occupant's driving motion is directed so as to prevent the occupants from feeling discomfort.

### SUMMARY

The present disclosure provides a technique that matches a more suitable driver to a user who desires to travel in a vehicle driven by another person.

An information processing apparatus according to a first aspect of the present disclosure includes a control unit configured to acquire first information on a behavior of a first vehicle associated with each operation performed by a first driver on the first vehicle, acquire second information on a change in emotion of a user who shares the first vehicle, extract information on the change in emotion of the user associated with each behavior of the first vehicle by associating the first information with the second information, determine a user's evaluation of the first driver's driving based on the change in emotion of the user associated with each behavior of the first vehicle, and store the evaluation in a storage unit.

With the present disclosure, it is possible to match a more suitable driver to the user who desires to travel in the vehicle driven by another person.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration example of an information

management system according to an embodiment;

FIG. 2 is a block diagram schematically illustrating one example of functional configurations of an in-vehicle device and a management server;

FIG. 3 is a diagram illustrating one example of a table configuration of the first information;

FIG. 4 is a diagram illustrating one example of a table configuration of the second information;

FIG. 5 is a diagram illustrating one example of a table configuration of user information stored in a user information database;

FIG. 6 is a diagram illustrating one example of a table configuration of driver information stored in a driver information database;

FIG. 7 is a flowchart illustrating a process of determining an evaluation of a driver's driving, which is made by a user who shares a vehicle;

FIG. 8 is a flowchart illustrating an evaluation determination process executed in S105 in the flowchart shown in FIG. 7;

FIG. 9 is a flowchart illustrating a process of matching the driver to the user who desires to use a ride-sharing service; and

FIG. 10 is a block diagram schematically illustrating one example of functional configurations of an in-vehicle device and a management server according to a modified example of the embodiment.

### DETAILED DESCRIPTION OF EMBODIMENTS

In an information processing apparatus according to a first aspect of the present disclosure, a control unit acquires first information and second information. The first information is information on a behavior of a first vehicle associated with each operation performed by a first driver on the first vehicle. For example, the first vehicle may be provided with various sensors that detect each operation performed by the first driver on the first vehicle, and various sensors that detect each behavior of the first vehicle. In this case, the control unit can acquire the first information based on sensor data from the various sensors.

The second information is information on a change in emotion of a user who shares the first vehicle. For example, the change in emotion of the user may be reflected in the user's biological information or a sound made by the user. Therefore, the control unit may acquire the second information based on the biological information of the user who shares the first vehicle. Moreover, the control unit may acquire the second information based on the sound made by the user inside the first vehicle.

The control unit extracts information on the change in emotion of the user associated with each behavior of the first vehicle by associating the first information with the second information. The change in emotion of the user inside the first vehicle does not have to be caused by the behavior of the first vehicle. Therefore, information on the change in emotion of the user is extracted at a timing in which the first vehicle exhibits a certain behavior as the first driver operates the first vehicle in a certain way, based on the first information and the second information. Consequently, it is possible to extract information on the change in emotion of the user associated with each behavior of the first vehicle.

Furthermore, the control unit determines a user's evaluation of the first driver's driving based on information on the change in emotion of the user associated with each behavior of the first vehicle. For example, the behavior of the first vehicle may cause a positive change in emotion or a negative change in emotion in the user. At this time, it is possible to determine whether the user's evaluation of the first driver's driving is high or low by comprehensively evaluating the positive and negative changes in emotion occurring in the user while the user is sharing the first vehicle.

The control unit stores the determined evaluation by the user of the first driver's driving in a storage unit. Accordingly, the information processing apparatus is able to find which drivers and their driving styles are preferred or not preferred by the user who shares the first vehicle. Therefore, the next time the user desires to travel in the vehicle, it is possible to match the user with a driver whose driving is highly likely to be preferred by the user.

Hereinafter, specific embodiments of the present disclosure will be described referring to the drawings. The technical scope of the present disclosure is not limited to dimensions, materials, shapes, and relative arrangements of the components described in the present embodiment unless otherwise specified.

### Embodiments

Outline of System

An embodiment that will be descried hereinbelow is an embodiment in a case where an information management system used in a ride-sharing service employs the information processing apparatus, the information processing method, and the program according to the present disclosure. The ride-sharing service is a service that provides a driver and a vehicle to the user who desires to travel in a vehicle driven by another person. Furthermore, the information processing apparatus, the information processing method, and the program according to the present disclosure may also be employed in an information management system of a taxi dispatch service.

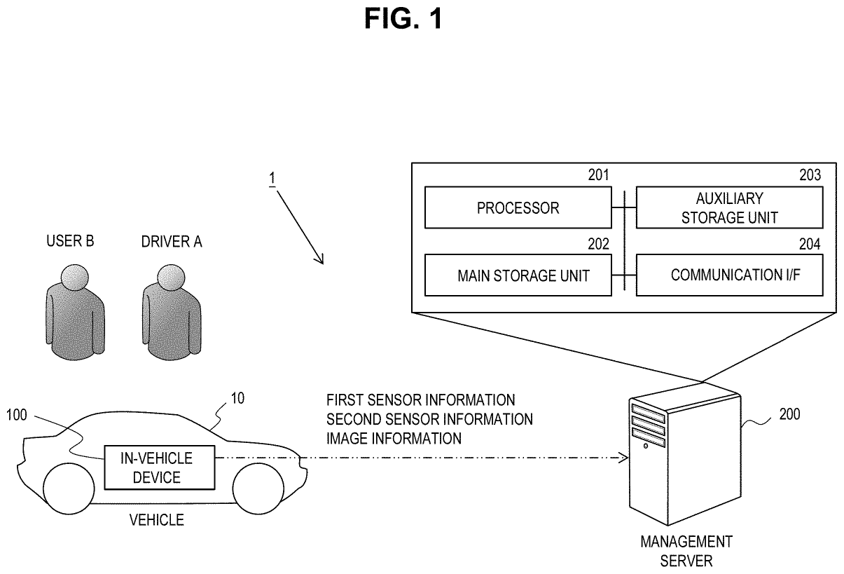

FIG. 1 is a diagram illustrating a schematic configuration example of an information management system according to the present embodiment. An information management system 1 is a system that manages information on a user who uses the ride-sharing service. The information management system 1 includes an in-vehicle device 100 mounted on the vehicle 10 and a management server 200. The vehicle 10 is a vehicle used for the ride-sharing service. In FIG. 1, the vehicle 10 is driven by a driver A. A user B who is the user of the ride-sharing service shares the vehicle 10. The management server 200 is a server device that receives a request from each user who desires to use the ride-sharing service.

In the information management system 1, the in-vehicle device 100 and the management server 200 are connected to each other by a network. The network may be, for example, a worldwide public communication network such as Internet or the like, and a WAN (Wide Area Network) or a telecommunications network such as a cellular network. The management server 200 includes a general computer. A computer constituting the management server 200 includes a processor 201, a main storage unit 202, an auxiliary storage unit 203, and a communication interface (communication I/F) 204.

The processor 201 is, for example, a central processing unit (CPU) or a digital signal processor (DSP). The main storage unit 202 may be, for example, a random access memory (RAM). The auxiliary storage unit 203 may be, for example, a read only memory (ROM), a hard disk drive (HDD), or a flash memory. Furthermore, the auxiliary storage unit 203 may include a removable medium (portable storage medium). The removable medium may include, for example, a USB memory, an SD card, or alternatively, a disk recording medium such as a CD-ROM, a DVD, or a Blu-ray Disc. The communication I/F 204 may be, for example, a LAN (local area network) interface board or a wireless communication circuit for wireless communication.

The auxiliary storage unit 203 stores an operating system (OS), various programs, various tables, and the like. The processor 201 loads the program stored in the auxiliary storage unit 203 into the main storage unit 202 and executes same, whereby the various processes are implemented for matching the driver to the user in the ride-sharing service, which will be described later. Some or all of the functions of the management server 200 may be implemented by a hardware circuit such as ASIC or FPGA. Moreover, the management server 200 does not have to be implemented by a single physical configuration, and may be configured by a plurality of computers that cooperate with each other.

The management server 200 receives first sensor information, second sensor information, and image information from the in-vehicle device 100 mounted on the vehicle 10. The first sensor information and the second sensor information are information including sensor data output from various sensors provided in the vehicle 10. The first sensor information includes sensor data output from each sensor that detects various operations performed by the driver A on the vehicle 10. The second sensor information includes sensor data output from each sensor that detects various behaviors of the vehicle 10. Furthermore, the image information is information including an image of the user B captured inside the vehicle 10.

In the management server 200, the first information is acquired based on the first sensor information and the second sensor information, which is information on the behavior of the vehicle 10 associated with each operation performed by the driver A on the vehicle 10. Further, in the management server 200, the second information is acquired based on the image information, which is information on the change in emotion of the user B who shares the vehicle 10. The emotion of the user B may become more negative or positive depending on the behavior of the vehicle 10 driven by the driver A. That is, if the user B likes the driving of the vehicle 10 performed by the driver A, it is considered that the emotion of the user B becomes more positive. Meanwhile, if the user B dislikes the driving of the vehicle 10 performed by the driver A, it is considered that the emotion of the user B becomes more negative.

Therefore, in the management server 200, the user B's evaluation of the driver A's driving is determined based on the first information and the second information. Further, the determined evaluation is stored in a database described later, which is constructed in the auxiliary storage unit 203. The management server 200 will determine a driver matched to the user B based on the user B's evaluation of the driver A's driving, stored in the database, the next time it receives a request for the ride-sharing service from the user B.

Functional Configuration

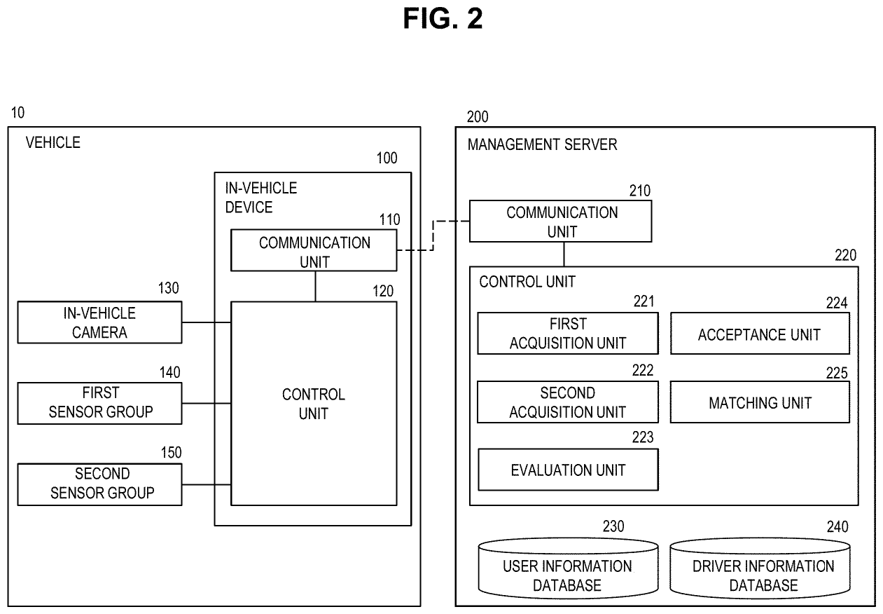

Functional configurations of the in-vehicle device 100 and the management server 200, constituting the information management system 1 according to the present embodiment, will be described referring to FIG. 2. FIG. 2 is a block diagram schematically illustrating one example of the functional configurations of the in-vehicle device 100 and the management server 200, respectively, according to the present embodiment. Hereinbelow, each functional configuration will be described on the premise that the driver A and the user B are traveling in the vehicle 10, as in FIG. 1.

In-vehicle Device

An in-vehicle camera 130, a first sensor group 140, and a second sensor group 150, in addition to the in-vehicle device 100, are mounted on the vehicle 10. The in-vehicle camera 130 is a camera that captures the image of the user B who shares the vehicle 10. The image captured by the in-vehicle camera 130 may be a moving image or a still image.

The first sensor group 140 is configured by a plurality of sensors that detect the various operations performed by the driver A on the vehicle 10. Sensors included in the first sensor group 140 may be, for example, an accelerator position sensor, a brake position sensor, and a steering sensor. The accelerator position sensor can detect the operation of the driver A of starting or accelerating the vehicle 10. The brake position sensor can detect the operation of the driver A of stopping or decelerating the vehicle 10. The steering sensor can detect the operation of the driver A of turning the vehicle 10 right or left. The various operations performed by the driver A and detected by the sensors included in the first sensor group 140 are, however, not limited to these operations. For example, operations such as changing lanes or traveling on a curved road may be detected.

The second sensor group 150 is configured by a plurality of sensors that detect the various behaviors of the vehicle 10. Sensors included in the second sensor group 150 may be, for example, an acceleration sensor that detects acceleration in each of three axial directions (longitudinal direction, lateral direction, and vertical direction) of the vehicle 10, and a yaw rate sensor that detects angular acceleration of the vehicle 10.

Moreover, the in-vehicle device 100 is also configured by including a computer dedicated to being mounted on the vehicle. The in-vehicle device 100 includes a communication unit 110 and a control unit 120. The communication unit 110 has a function of connecting the in-vehicle device 100 to the network. The communication unit 110 may be implemented by a communication interface included in the computer constituting the in-vehicle device 100. The control unit 120 has a function of executing an arithmetic process required for controlling the in-vehicle device 100. The control unit 120 may be implemented by a processor included in the computer constituting the in-vehicle device 100.

In the vehicle 10, the in-vehicle device 100 establishes communication with the in-vehicle camera 130, the first sensor group 140, and the second sensor group 150 via a predetermined in-vehicle network. The control unit 120 receives the image information including the image captured by the in-vehicle camera 130. The control unit 120 receives the sensor data detected by each sensor of the first sensor group 140 and the second sensor group 150.

Furthermore, the control unit 120 executes a process of transmitting the image information received from the in-vehicle camera 130 to the management server 200 using the communication unit 110. Meanwhile, the control unit 120 executes a process of transmitting the first sensor information including the sensor data received from the first sensor group 140 to the management server 200 using the communication unit 110. The control unit 120 executes a process of transmitting, to the management server 200 using the communication unit 110, the second sensor information including the sensor data received from the second sensor group 150

A vehicle ID, which is identification information for identifying the vehicle 10, is attached to the information transmitted from the in-vehicle device 100 to the management server 200. Furthermore, a timestamp, which indicates a timing at which the image is captured by the in-vehicle camera 130, is attached to the image information transmitted from the in-vehicle device 100 to the management server 200. Timestamps indicating a timing at which the sensor data is detected by each sensor are attached to the first sensor information and the second sensor information, respectively, transmitted from the in-vehicle device 100 to the management server 200.

Management Server

The management server 200 includes a communication unit 210, a control unit 220, a user information database (user information DB) 230, and a driver information database (driver information DB) 240. The communication unit 210 has a function of connecting the management server 200 to the network. The communication unit 210 is implemented by a communication I/F 204. The control unit 220 has a function of executing an arithmetic process required for controlling the management server 200. The control unit 220 is implemented by a processor 201.

The control unit 220 executes a process of receiving the image information, the first sensor information and the second sensor information, transmitted from the in-vehicle device 100 using the communication unit 210. The control unit 220 also executes a process of receiving request information on the requests of each user who desires to use the ride-sharing service, using the communication unit 210. The request information may be transmitted from a terminal related to the user who desires to use the ride-sharing service (that is, the user who has not yet boarded the vehicle 10).

The control unit 220 includes a first acquisition unit 221, a second acquisition unit 222, an evaluation unit 223, an acceptance unit 224, and a matching unit 225. The first acquisition unit 221 has a function of acquiring the first information on the behavior of the vehicle 10 associated with each operation performed by the driver A on the vehicle 10, by associating the first sensor information with the second sensor information, which are received from the in-vehicle device 100.

As stated above, the timestamp indicating a timing at which the sensor data is detected by each sensor provided in the vehicle 10 is attached to the first sensor information and the second sensor information, respectively. Consequently, it is possible to associating the operation performed by the driver A on the vehicle 10, indicated by the sensor data included in the first sensor information, with the behavior of the vehicle 10, indicated by the sensor data included in the second sensor information, which occur at a certain timing while the driver A is driving the vehicle 10. Accordingly, the first acquisition unit 221 can identify the behavior of the vehicle 10 which occurs when a certain operation is performed by the driver A on the vehicle 10.

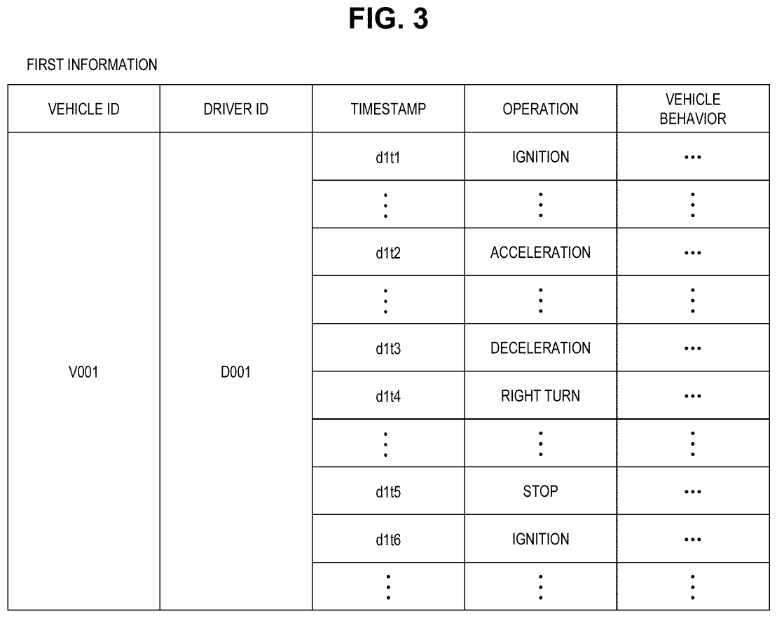

FIG. 3 is a diagram illustrating one example of a table configuration of the first information acquired by the first acquisition unit 221. The first information shown in FIG. 3 includes a vehicle ID field, a driver ID field, a timestamp field, an operation field, and a vehicle behavior field. A vehicle ID that identifies the vehicle 10 provided with the in-vehicle device 100, which transmits the first sensor information and the second sensor information, is entered into the vehicle ID field. A driver ID, which is an identification number for identifying the driver A who is driving the vehicle 10, is entered into the driver ID field. In the management server 200, the vehicle ID of the vehicle 10 and the driver ID of the driver A who is driving the vehicle 10 are associated with each other and stored in the database. Accordingly, the driver ID corresponding to the vehicle ID attached to the first sensor information and the second sensor information, received from the in-vehicle device 100, can be acquired from the database.

The timestamps, which are attached to the first sensor information and the second sensor information while corresponding to each operation and each behavior, are entered into the timestamp field. The operation performed by the driver A on the vehicle 10, indicated by the sensor data included in the first sensor information, is entered into the operation field. For example, the operations performed by the driver A on the vehicle 10 and entered into the operation field include ignition, stop, acceleration, deceleration, left turn, and right turn. The behavior of the vehicle 10, indicated by the sensor data included in the second sensor information, is entered into the vehicle behavior field. For example, the behaviors of the vehicle 10 entered into the vehicle behavior field include direction and degree of the acceleration occurring in the vehicle 10, or direction and degree of the yaw rate occurring in the vehicle 10. Consequently, the operation performed by the driver A on the vehicle 10 and the behavior of the vehicle 10, made at each timing (date and time) entered into the timestamp field, are associated with each other and stored in the table of the first information.

Furthermore, the second acquisition unit 222 has a function of acquiring the second information on the change in emotion of the user B who shares the vehicle 10, based on the image information received from the in-vehicle device 100. In particular, the second acquisition unit 222 detects the biological information of the user B from the image of the user B included in the image information, which is received from the in-vehicle device 100. The detected biological information is information indicating the change in emotion of the user B, for example, information indicating facial expression, line of sight, posture, or body motion of the user B. Information such as body temperature, respiratory rate, or pulse may be detected from the image of the user B as the biological information indicating the change in emotion of the user B. The user B who shares the vehicle 10 may wear a wearable sensor that detects the biological information of the user B. In this case, the management server 200 may receive the biological information indicating the change in emotion of the user B detected by the wearable sensor.

The second acquisition unit 222 derives the change in emotion of the user B based on the biological information of the user B, detected from the image of the user B. That is, in a case where the emotion of the user B sharing the vehicle 10 becomes more positive or negative, the change in emotion is reflected in the biological information of the user B. The change in emotion of the user is derived by the second acquisition unit 222 based on the biological information of the user B. At this time, the second acquisition unit 222 derives an emotion level which is a numerical value indicating a degree of positivity when the emotion of the user B becomes more positive or a degree of negativity when the emotion of the user B becomes more negative.

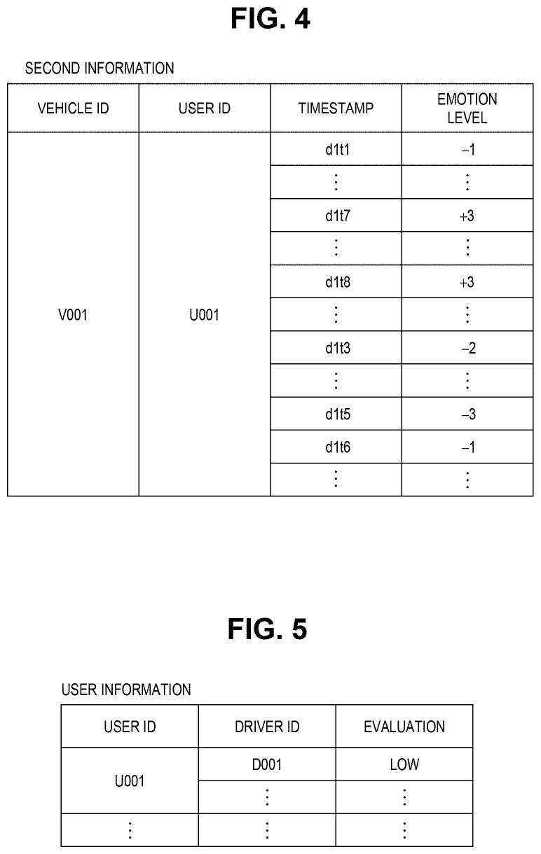

FIG. 4 is a diagram illustrating one example of a table configuration of the second information acquired by the second acquisition unit 222. The second information shown in FIG. 4 includes a vehicle ID field, a user ID field, a timestamp field, and an emotion level field. The vehicle ID that identifies the vehicle 10 provided with the in-vehicle device 100, which transmits the image information, is entered into the vehicle ID field. A user ID, which is an identification number for identifying the user B who shares the vehicle 10, is entered into the user ID field. In the management server 200, the vehicle ID of the vehicle 10 and the user ID of the user B who shares the vehicle 10 are associated with each other and stored in the database. Accordingly, the user ID corresponding to the vehicle ID attached to the image information, received from the in-vehicle device 100, can be acquired from the database.

A timestamp corresponding to the image and attached to the image information is entered into the timestamp field. The emotion level derived based on the image information is entered into the emotion level field. For example, in the table shown in FIG. 4, the emotion level indicating the positive change in emotion may be entered as a positive (+) numerical value, and the emotion level indicating the negative change in emotion may be entered as a negative (−) numerical value. As stated above, the emotion level indicating the change in emotion of the user B at each timing (date and time) entered into the timestamp field is stored in the table of the second information.

As stated above, in the present embodiment, the second information on the change in emotion of the user B is acquired based on the biological information about the user B, detected from the image of the user B. However, how to acquire the second information is not limited thereto. For example, in a case where a microphone is provided in the vehicle 10, a sound made by the user B who shares the vehicle 10 can be detected. The change in emotion of the user B may be reflected in the sound made by the user B. Therefore, sound information including the sound made by the user B inside the vehicle 10 may be transmitted from the in-vehicle device 100 to the management server 200. The management server 200 may acquire the second information based on the user's sound included in the sound information. The second information may be acquired using both the image of the user B and the sound made by the user B. Furthermore, the second information may be acquired by detecting the change in emotion of the user B who shares the vehicle 10, by other well-known methods.

The evaluation unit 223 determines the user B's evaluation of the driver A's driving, based on the first information acquired by the first acquisition unit 221, and the second information acquired by the second acquisition unit 222. The change in emotion of the user B who shares the vehicle 10 does not have to be caused by the behavior of the vehicle 10. For example, the emotion of the user B may become more positive or negative due to the situation outside the vehicle or scenes seen from the inside of the vehicle 10. Consequently, the evaluation unit 223 extracts information on the change in emotion of the user B associated with each behavior of the vehicle 10 by associating the first information with the second information.

As stated above, the first information indicates the operation performed by the driver A on the vehicle 10 and the behavior of the vehicle 10 at each timing (date and time) entered into the timestamp field. The second information also indicates the emotion level of the user B at each timing (date and time) entered into the timestamp field. In a case where, when the driver A operates the vehicle 10 to cause a certain behavior of the vehicle 10 at a certain timing, the emotion of the user B becomes more positive or negative at the same timing, it can be interpreted that the change in emotion of the user B occurs due to the behavior of the vehicle 10. The evaluation unit 223 extracts information on the change in emotion of the user B at a timing in which the first vehicle exhibits a certain behavior as the driver A operates the vehicle 10 in a certain way, based on the first information and the second information. For example, the second information shown in FIG. 4 may exhibit the respective emotion levels indicating the negative numerical values, corresponding to the negative change in emotion, when the timing entered into the timestamp field is “d1t1”, “d1t3”, “d1t5”, or “d1t6”. The first information shown in FIG. 3 indicates the respective behaviors of the vehicle 10, caused by the operation performed by the driver, when the timing entered into the timestamp field is “d1t1”, “d1t3”, “d1t5”, or “d1t6”. Therefore, the emotion levels at these timings are extracted as information on the change in emotion of the user B associated with the behavior of the vehicle 10 at each timing.

Furthermore, the evaluation unit 223 determines the user B's evaluation of the driver A's driving based on information on the change in emotion of the user B associated with each behavior of the vehicle 10. In particular, the evaluation unit 223 calculates an evaluation value indicating the user B's evaluation of the driver A's driving based on the respective emotion levels showing the change in emotion of the user B associated with each behavior of the vehicle 10. At this time, the evaluation unit 223 calculates the evaluation value by comprehensively evaluating the positive or negative change in emotion of the user (emotion levels) B at several timings. Any one of well-known algorithms may be employed as a specific algorithm for calculating the evaluation value. The evaluation unit 223 determines the user B's evaluation of the driver A's driving by comparing the calculated evaluation value with a predetermined threshold.

The control unit 220 stores the user B's evaluation of the driver A's driving, determined by the evaluation unit 223, as user information in the user information database 230. FIG. 5 is a diagram illustrating one example of a table configuration of the user information stored in the user information database 230. As shown in FIG. 5, the user information stored in the user information database 230 has a user ID field, a driver ID field, and an evaluation field. The user ID of each user who has used the ride-sharing service is entered into the user ID field. The driver ID of the driver to be evaluated by each user (i.e., the driver of the vehicle in which each user travels) is entered into the driver ID field. The user's evaluation of the driving of each driver is entered into the evaluation field. That is, the user B's evaluation of the driver A's driving, determined by the evaluation unit 223, is stored in the user information database 230 together with the user ID of the user B. The user information database 230 is built in the auxiliary storage unit 203 as the processor 201 executes the program of the database management system.

The acceptance unit 224 has a function of acquiring the request information on the request of each user who desires to use the ride-sharing service, received by the communication unit 210. The matching unit 225 has a function of matching the driver to the user in a case where the request information is accepted from the user via the acceptance unit 224. The driver information on each driver that can be matched to the user for the ride-sharing service is stored in the driver information database 240. The matching unit 225 selects a driver that matches the user from several drivers whose driver information is respectively stored in the driver information database 240. The driver information database 240 is built in the auxiliary storage unit 203.

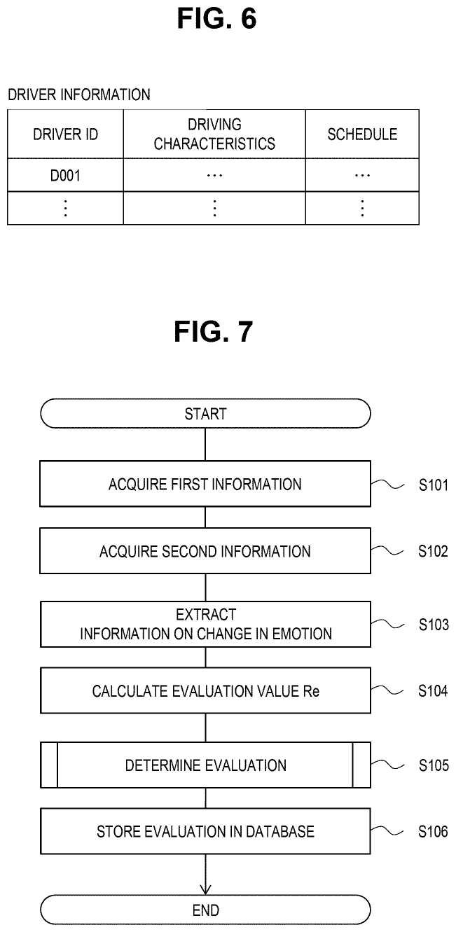

FIG. 6 is a diagram illustrating one example of a table configuration of the driver information stored in the driver information database 240. As shown in FIG. 6, the driver information stored in the driver information database 240 has a driver ID field, a driving characteristics field, and a schedule field. The driver ID of each driver is entered into the driver ID field. Information on driving characteristics of each driver is entered into the driving characteristics field. The information on the driving characteristics is information indicating the driving characteristics that each driver shows when he/she drives the vehicle 10. The information on the driving characteristics of each driver may be acquired based on the first information and the second information, which are received from the in-vehicle device 100 when each driver drives the vehicle 10. Information on a planned schedule of each driver is entered into the schedule field.

For example, the next time the user B who has shared the vehicle 10 desires to use the ride-sharing service, the request information is acquired by the acceptance unit 224 from the user B. The matching unit 225 determines the driver to be matched to the user B. At this time, the matching unit 225 determines the driver to be matched to the user B based on the user information on the user B stored in the user information database 230. The method for determining the driver to be matched to the user, employed in the matching unit 225, will be described later in detail.

Evaluation Determination Process

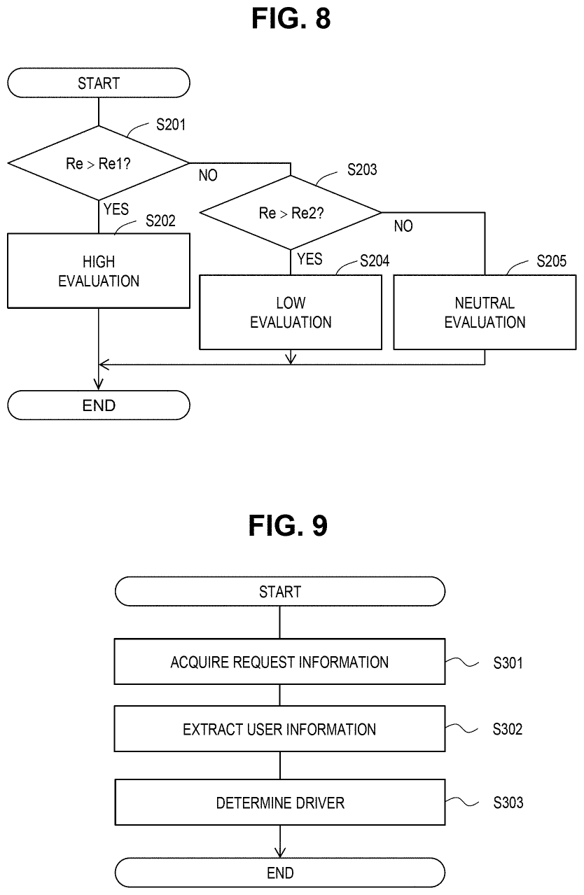

A flow of an information processing executed on the management server 200 will be described hereinbelow referring to FIGS. 7 to 9. FIGS. 7 and 8 are both flowcharts illustrating a process of determining the evaluation of the driver's driving, which is made by the user who shares the vehicle 10. This flow is executed by a control unit 220.

In this flow, in S101, the first information is acquired based on the first sensor information and the second sensor information, which are received from the in-vehicle device 100 of the vehicle 10. The second information is acquired based on the image information received from the in-vehicle device 100 of the vehicle 10 in S102. Information on the change in emotion of the user associated with each behavior of the vehicle 10 is extracted by associating the first information with the second information in S103. As stated above, the emotion level corresponding to each behavior of the vehicle 10 is extracted as information on the change in emotion of the user associated with each behavior. In S104, an evaluation value Re indicating the user's evaluation of the driver's driving is calculated based on the respective emotion levels showing the change in emotion of the user associated with each behavior of the vehicle 10, which are extracted in S103. The higher the user's evaluation of the driver's driving is, the larger the calculated evaluation value Re is.

In S105, the user's evaluation of the driver's driving is determined using the evaluation value Re calculated in S104. FIG. 8 is a flowchart illustrating an evaluation determination process executed in S105 in the flowchart shown in FIG. 7. In this flow, it is determined whether the evaluation value Re is larger than a first threshold Re1 in S201. In a case where it is determined as “YES” in S201, it is then determined that the user's evaluation of the driver's driving is high in S202. Meanwhile, in a case where it is determined as “NO” in S201, a process of S203 is executed.

In S203, it is determined whether the evaluation value Re is smaller than a second threshold Re2. The second threshold Re2 is a value smaller than the first threshold Re1. In S204, in a case where it is determined as “YES” in S203, it is then determined that the user's evaluation of the driver's driving is low. Meanwhile, in S205, in a case where it is determined as “NO” in S203, it is then determined that the user's evaluation of the driver's driving is neutral.

The process then return to the flow shown in FIG. 7. When the user's evaluation of the driver's driving is determined in S105, a process of S106 is executed. In S106, the evaluation determined in S105 is stored in the user information database 230 together with the user ID and the driver ID as the user information. The control unit 220 may calculate the evaluation value Re for each trip of the vehicle 10 and integrate the evaluation values Re for several trips to determine the user's evaluation of the driver's driving. The control unit 220 may store the user's evaluation of the driver's driving in association with a type of an area in which the vehicle 10 has traveled (for example, highway area, urban area, or suburban area), in the user information database 230.

Matching Process

FIG. 9 is a flowchart illustrating a process of matching the driver to the user who desires to use the ride-sharing service. This flow, along with the flows shown in FIGS. 7 and 8, is also executed by the control unit 220.

In this flow, the request information is acquired from the user who desires to use the ride-sharing service in S301. The user ID is attached to the request information. In S302, the user information corresponding to the user ID attached to the request information is extracted from the user information database 230. That is, the user information, which is stored in the user information database 230 when the user corresponding to the user ID attached to the request information has used the ride-sharing service, is extracted from the user information database 230.

The driver to be matched to the user is determined based on the evaluation for the driver included in the user information extracted in S302, that is, the driver who has been matched to the user. At this time, as stated above, the matching unit 225 determines the driver that matches the user from several drivers whose driver information is respectively stored in the driver information database 240. For example, in a case where the evaluation of a driver X included in the user information is high, the driver information of the driver X is searched in the driver information database 240. Furthermore, it is determined whether the driver X is available for the user this time, based on the planned schedule included in the driver information of the driver X. If the driver X is available, the driver to be matched to the user is determined as the driver X. On the other hand, if it is determined that the driver X is not available due to their schedule, another driver Y having driving characteristics similar to those of the driver X is searched for in the driver information database 240. If the other driver Y is available referring to the schedule, the driver to be matched to the user is determined as the driver Y. In a case where the user information includes a low evaluation of a driver Z, the driver to be matched to the user is determined as one of drivers other than the driver Z and drivers having driving characteristics similar to those of the driver Z.

As stated above, according to the information management system 1 of the present embodiment, the management server 200 can find which drivers and driving styles are preferred or not preferred by the user who shares the vehicle 10. Therefore, the next time the user desires to use the ride-sharing service, it is possible to match the user with a driver whose driving is highly likely to be preferred by the user.

In the present embodiment, the management server 200 acquires the change in emotion of the user associated with each behavior of the vehicle as the emotion level, and calculates the evaluation value based on each acquired emotion level in order to determine the user's evaluation of the driver's driving. However, it is not necessary to calculate such an evaluation value. That is, the evaluation unit 223 may evaluate and determine by another method without using the evaluation value, as long as it is possible to determine whether the user likes the driver's driving based on the change in emotion of the user associated with each behavior of the vehicle.

### Modified Example

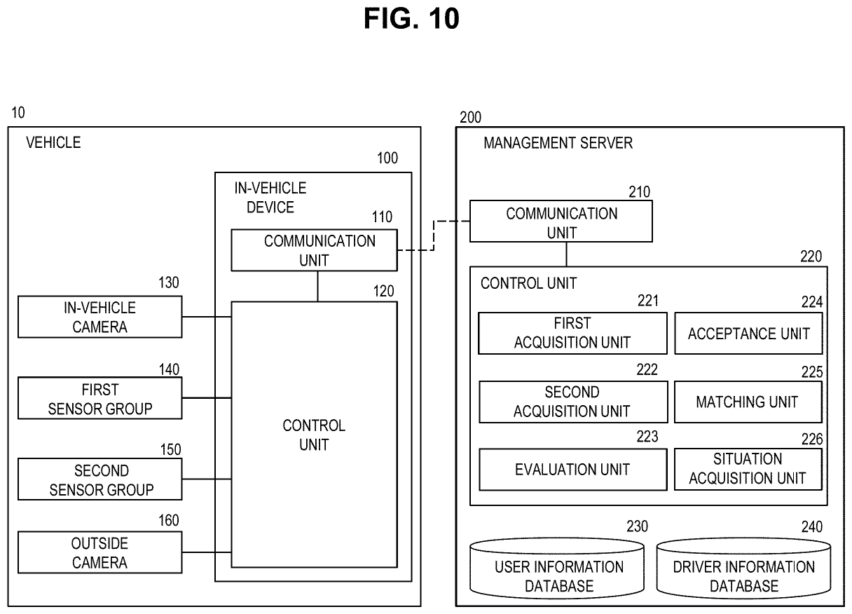

A modified example of the present embodiment will be described hereinbelow. FIG. 10 is a block diagram schematically illustrating one example of the functional configurations of the in-vehicle device 100 and the management server 200, respectively, according to the modified example.

As shown in FIG. 10, in this modified example, the vehicle 10 is provided with an outside camera 160 in addition to the in-vehicle camera 130. The outside camera 160 is a camera that captures an image around the vehicle 10. The image captured by the outside camera 160 may be a moving image or a still image. The control unit 120 receives image information including an image captured by the outside camera 160. In addition, the control unit 120 executes a process of transmitting, to the management server 200 using the communication unit 110, the image information including the image captured by the outside camera 160 (hereinafter, sometimes referred to as “second image information”), in addition to the image information including the image captured by the in-vehicle camera 130. At this time, a timestamp, which indicates a timing at which the image is captured by the outside camera 160, is attached to the second image information transmitted from the in-vehicle device 100 to the management server 200.

In this modified example, the control unit 220 of the management server 200 includes a situation acquisition unit 226, in addition to the first acquisition unit 221, the second acquisition unit 222, the evaluation unit 223, the acceptance unit 224, and the matching unit 225. The situation acquisition unit 226 has a function of acquiring situation information on a situation around the vehicle 10 based on the second image information received from the in-vehicle device 100. The situation information includes the timestamp attached to the second image information received from the in-vehicle device 100. Therefore, the control unit 220 can identify a timing at which each situation included in the situation information occurs.

For example, when a person or an object suddenly appears in front of a vehicle 10 in the traveling direction of the vehicle 10 that the user travels in, the driver is required to operate the vehicle 10 so as to avoid a collision with the person or the object suddenly appearing in front of the vehicle (evasive action). The user's emotion may significantly change due to the behavior of the vehicle 10 caused by the evasive action at this time. However, the evasive action in such a case has little relevance to the driving characteristics of the driver. Therefore, if the change in emotion of the user caused by the behavior of the vehicle 10 due to the evasive action affects the evaluation of the driver's driving, accuracy of the evaluation may decrease.

According to this modified example, in the management server 200, the control unit 220 determines whether each situation included in the situation information acquired by the situation acquisition unit 226 satisfies a predetermined condition. The predetermined condition is a situation in which it can be determined that the driver needs to perform an operation having a low relevance to the driving characteristics of the driver, such as the evasive action stated above. As stated above, the predetermined condition may include a condition in which the person or the object suddenly appears in front of the vehicle 10 in the traveling direction of the vehicle 10.

In a case where the situation information may include a situation satisfying the predetermined condition, when determining the user's evaluation of the driver's driving, the information detected when such a situation occurs around the vehicle 10 is excluded from the first information and the second information. That is, information for which the timestamp entered into the timestamp field corresponds to a date and time when the situation satisfying the predetermined condition occurs is excluded from the first information and the second information.

Consequently, the emotion level indicating the change in emotion of the user when the situation satisfying the predetermined condition occurs is not used for the calculation of the evaluation value Re. The change in emotion of the user caused by the behavior of the vehicle 10 due to the operation which has a low relevance in terms of the driving characteristics of the driver does not have much of an effect on the determination of the user's evaluation of the driver's driving. Therefore, it is possible to more accurately determine the user's evaluation of the driver's driving.

### Other Embodiments

The embodiments stated above are mere examples, and the present disclosure can be implemented with appropriate modifications within a scope not departing from the gist thereof. For example, the processing and units described in the present disclosure can be freely combined and implemented unless technical contradiction occurs.

Further, the process described as being performed by a single device may be executed in a shared manner by a plurality of devices. Alternatively, the process described as being performed by different devices may be executed by a single device. In the computer system, the hardware configuration (server configuration) for implementing each function can be flexibly changed.

The present disclosure can also be implemented by supplying a computer program for executing the functions described in the embodiments in a computer, and reading and executing the program by one or more processors included in the computer. Such a computer program may be provided to the computer by a non-transitory computer-readable storage medium connectable to a computer system bus, or may be provided to the computer via the network. Examples of the non-transitory computer-readable storage media include random disk (such as a magnetic disk (floppy (registered trademark) disk, hard disk drive (HDD), and the like) or optical disk (CD-ROM, DVD disk, Blu-ray disk, and the like)), read-only memory (ROM), random access memory (RAM), EPROM, EEPROM, magnetic card, flash memory, optical card, and a random type of medium suitable for storing electronic instructions.

What is claimed is:

1. An information processing apparatus comprising:
a control unit configured to:
acquire first information on a behavior of a first vehicle associated with each operation performed by a first driver on the first vehicle;
acquire second information on a change in emotion of a user who shares the first vehicle;
extract information on the change in emotion of the user associated with each behavior of the first vehicle by associating the first information with the second information;
determine a user's evaluation of the first driver's driving based on the change in emotion of the user associated with each behavior of the first vehicle; and
store the evaluation in a storage unit.

2. The information processing apparatus according to claim 1, wherein:
the control unit is configured to calculate an evaluation value indicating the evaluation of the first driver's driving based on the change in emotion of the user associated with each behavior of the first vehicle; and
the evaluation value is compared with a predetermined threshold to determine the user's evaluation of the first driver's driving.

3. The information processing apparatus according to claim 1, wherein:
the control unit is configured to acquire information on a situation around the first vehicle; and
information detected when the situation around the first vehicle satisfies a predetermined condition is excluded from the first information and the second information.

4. The information processing apparatus according to claim 3, wherein the predetermined condition includes a condition where a person or an object appears in front of the first vehicle in a traveling direction of the first vehicle.

5. The information processing apparatus according to claim 1, wherein the control unit is configured to determine a driver to be matched with the user next time based on the evaluation stored in the storage unit.

6. The information processing apparatus according to claim 5, wherein:
information on driving characteristics of each of a plurality of drivers, including the first driver, is stored in the storage unit; and
the control unit is configured to, in a case where the user's evaluation of the first driver's driving which is stored in the storage unit is a predetermined evaluation, determine the first driver or a driver having driving characteristics similar to the driving characteristics of the first driver, from among the plurality of drivers, as the driver to be matched with the user next time.

7. The information processing apparatus according to claim 1, wherein the control unit is configured to acquire the second information based on biological information of the user.

8. The information processing apparatus according to claim 7, wherein the biological information of the user is detected from an image of the user which is captured inside the first vehicle.

9. The information processing apparatus according to claim 1, wherein the control unit is configured to acquire the second information based on a sound made by the user inside the first vehicle.

10. An information processing method executed by a computer, the information processing method comprising:
acquiring first information on a behavior of a first vehicle associated with each operation performed by a first driver on the first vehicle;
acquiring second information on a change in emotion of a user who shares the first vehicle;
extracting information on the change in emotion of the user associated with each behavior of the first vehicle by associating the first information with the second information;
determining a user's evaluation of the first driver's driving based on the change in emotion of the user associated with each behavior of the first vehicle; and
storing the evaluation in a storage unit of the computer.

11. The information processing method according to claim 10, further comprising calculating an evaluation value indicating the evaluation of the first driver's driving based on the change in emotion of the user associated with each behavior of the first vehicle,
wherein the evaluation value is compared with a predetermined threshold to determine the user's evaluation of the first driver's driving.

12. The information processing method according to claim 10, further comprising acquiring information on a situation around the first vehicle,
wherein information detected when the situation around the first vehicle satisfies a predetermined condition is excluded from the first information and the second information.

13. The information processing method according to claim 12, wherein the predetermined condition includes a condition where a person or an object appears in front of the first vehicle in a traveling direction of the first vehicle.

14. The information processing method according to claim 10, further comprising determining a driver to be matched with the user next time based on the evaluation stored in the storage unit.

15. The information processing method according to claim 14, wherein:
information on driving characteristics of each of a plurality of drivers, including the first driver, is stored in the storage unit; and
in a case where the user's evaluation of the first driver's driving stored in the storage unit is a predetermined evaluation, the first driver or a driver having driving characteristics similar to the driving characteristics of the first driver, from among the plurality of drivers, is determined as the driver to be matched with the user next time.

16. The information processing method according to claim 10, wherein the second information is acquired based on biological information of the user.

17. The information processing method according to claim 16, wherein the biological information of the user is detected from an image of the user which is captured inside the first vehicle.

18. The information processing method according to claim 10, wherein the second information is acquired based on a sound made by the user inside the first vehicle.

19. A program causing a computer to execute an information processing method, the information processing method comprising:
acquiring first information on a behavior of a first vehicle associated with each operation performed by a first driver on the first vehicle;
acquiring second information on a change in emotion of a user who shares the first vehicle;
extracting information on a change in emotion of the user associated with each behavior of the first vehicle by associating the first information with the second information;
determining a user's evaluation of the first driver's driving based on the change in emotion of the user associated with each behavior of the first vehicle; and
storing the evaluation in a storage unit of the computer.

20. The program according to claim 19, wherein the information processing method further includes determining a driver to be matched with the user next time based on the evaluation stored in the storage unit.
